(19) United States
(12) Patent Application Publication
(10) Pub. No.: US 2008/0276526 A1
(43) Pub. Date: Nov. 13, 2008

(54) NUTRIENT SUPPLYING BAG FOR PLANTS

(76) Inventor: Tsun-tsung Tsai, Dashe Township (TW)

Correspondence Address: KIRTON AND MCCONKIE, 60 EAST SOUTH TEMPLE,, SUITE 1800, SALT LAKE CITY, UT, 84111, US

(21) Appl. No.: 12/109,041

(22) Filed: Apr. 24, 2008

(30) Foreign Application Priority Data
May 7, 2007 (TW) 096207277

(51) Int. Cl. A01G 29/00

(52) U.S. Cl. 47/48.5

(57) ABSTRACT

A nutrient supplying bag for plants includes an upper bag portion, a lower bag portion, and a receiving space. The upper bag portion defines a first surface of the nutrient supplying bag, and is formed with a liquid inlet. The lower bag portion defines a second surface of the nutrient supplying bag opposite to the first surface thereof. The lower bag portion has at least one side edge which is correspondingly seal-connected to at least one side edge of the upper bag portion, and further has at least one liquid outlet. The receiving space is formed between the upper bag portion and the lower bag portion for receiving a fertilizer. The liquid inlet is used to fill a liquid into the receiving space to dissolve nutrients of the fertilizer, and the liquid outlet is used to drain the nutrients of the dissolved fertilizer for fertilizing plants.

### FIELD OF THE INVENTION

The present invention relates to a nutrient supplying bag for plants, and more particularly to a supplying bag having a receiving space for receiving a fertilizer, a liquid inlet for filling a liquid to dissolve the fertilizer, and at least one liquid outlet for draining the fertilizer dissolved in the receiving space, so as to supply nutrients of the fertilizer to plants.

### BACKGROUND OF THE INVENTION

A typical cultivating method in agriculture includes steps of: cultivating a seedling in a pot or the like for a period of time; and then moving the seedling that has grown to a desired state to a cultivation place. Furthermore, potted plants are generally used to decorate the environment for gardening. Thus, adequate fertilization is required for plants to grow well within a desired period. Traditionally, a fertilizer can be placed into the soil of a potted plant, but the temperature of the soil may rise due to a chemical reaction of the fertilizer placed in the soil, resulting in adversely affecting growth of the plant. Therefore, referring now to FIG. 1, a fertilizer 9 may be directly spread on the soil and then wetted by watering, so that nutrients of the fertilizer 9 will be dissolved and leaked into the soil, for the purpose of being absorbed by roots of the plant.

However, in fact, the foregoing fertilizing method for the potted plant causes several disadvantages. First, the fertilizer 9 on the soil adversely affects the aesthetic impression of the whole environment where the potted plant is used for decoration and gardening. Secondly, the fertilizer 9 may attract insects and thus cause hygienic problems. Thirdly, the fertilizer 9 may generate uncomfortable smells and thus degrade the quality and comfort of living. Lastly, although the fertilizer 9 is spread over the soil and wetted by watering, the liquid cannot fully dissolve the nutrients of the fertilizer 9 before the liquid is leaked into the soil, resulting in poor fertilization efficiency for the plant.

To solve the following problems, related manufacturers developed various nutrient supplying devices for plants, such as U.S. Pat. No. 5,022,182; U.S. Pat. No. 5,942,021; JP Published Pat. No. 06-092767; JP Published Pat. No. 08-026876; and JP Published Pat. No. 11-056055. Generally, the nutrient supplying devices can not be reused. Meanwhile, some of the nutrient supplying devices have water-permeable bag for receiving fertilizer, but the fertilizer therein may be quickly leaked out of the water-permeable bag during watering or raining. Furthermore, in a sunny day, the water in the water-permeable bag may be quickly evaporated, resulting in lower the fertilizing efficiency of the nutrient supplying devices.

As a result, it is important to think how to provide a fertilizing method for the potted plant, in order to solve the foregoing problems.

### SUMMARY OF THE INVENTION

To solve the problems existing in the foregoing prior art, the present invention provides a bag for receiving a fertilizer, wherein the bag has an upper bag portion with at least one liquid inlet for filling a liquid into the bag and dissolving the fertilizer, and the bag further has at least one liquid outlet for draining nutrients of the dissolved fertilizer, so that the nutrients thereof can be leaked into the soil of a pot, for the purpose of efficiently enhancing the solubility of the fertilizer and improving hygienic problems thereof.

A primary object of the present invention is to provide a nutrient supplying bag for plants, which is provided with a liquid inlet, a receiving space, and at least one liquid outlet, so as to dissolve a fertilizer and drain nutrients of the dissolved fertilizer. As a result, the solubility of the fertilizer can be efficiently enhanced.

A secondary object of the present invention is to provide a nutrient supplying bag for plants, which is provided with a separation screen between a liquid inlet and a receiving space, so as to prevent insects from entering the receiving space. As a result, hygienic problems of fertilizing the plants can be efficiently improved.

To achieve the above object, the present invention discloses a nutrient supplying bag for plants, which includes an upper bag portion, a lower bag portion, and a receiving space. The upper bag portion defines a first surface of the nutrient supplying bag, and is formed with a liquid inlet. The lower bag portion defines a second surface of the nutrient supplying bag opposite to the first surface thereof. The lower bag portion has at least one side edge which is correspondingly seal-connected to at least one side edge of the upper bag portion, and further has at least one liquid outlet. The receiving space is formed between the upper bag portion and the lower bag portion for receiving a fertilizer. The liquid inlet is used to fill a liquid into the receiving space to dissolve nutrients of the fertilizer, and the liquid outlet is used to drain the nutrients of the dissolved fertilizer for fertilizing plants.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view of a traditional fertilizer for a potted plant;

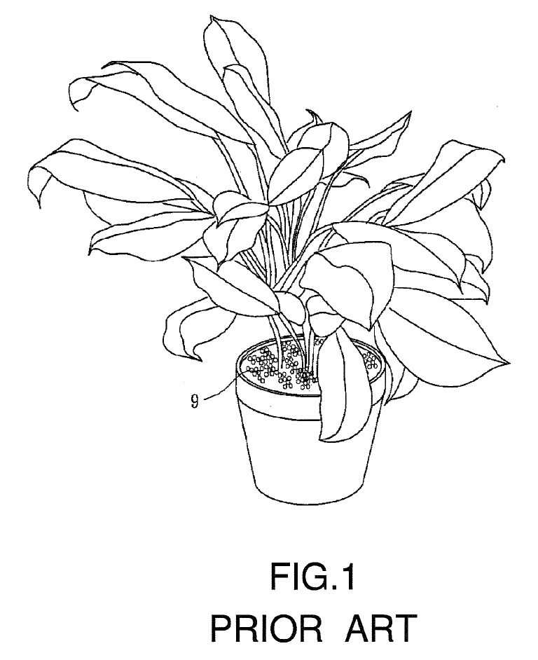

FIG. 2 is an assembled perspective view of a nutrient supplying bag for plants according to a first preferred embodiment of the present invention;

FIG. 3 is a cross-sectional view of the nutrient supplying bag according to the first preferred embodiment of the present invention;

FIG. 4 is an operational view of the nutrient supplying bag used for fertilizing plants according to the first preferred embodiment of the present invention;

FIG. 5 is a cross-sectional view of the nutrient supplying bag used for fertilizing plants according to the first preferred embodiment of the present invention; and

FIG. 6 is an assembled perspective view of a nutrient supplying bag for plants according to a second preferred embodiment of the present invention.

### DETAILED DESCRIPTION OF THE PREFERRED EMBODIMENTS

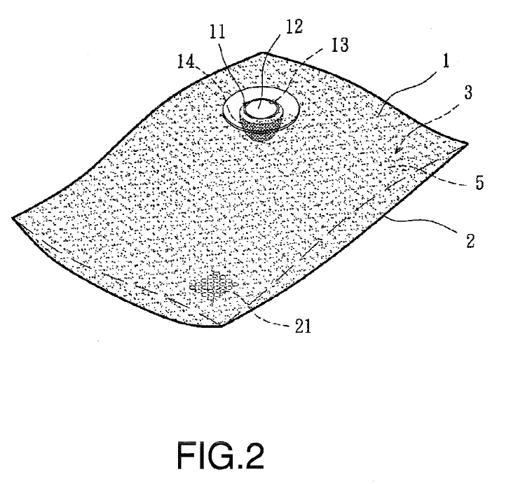

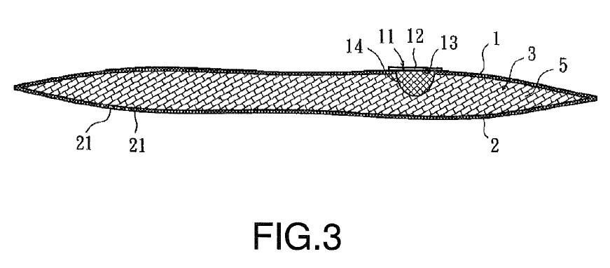

Referring now to FIGS. 2 and 3, a nutrient supplying bag for plants according to a first preferred embodiment of the present invention is illustrated. As shown, the nutrient supplying bag comprises an upper bag portion 1, a lower bag portion 2, and a receiving space 3. The upper bag portion 1 defines a first surface of the nutrient supplying bag, while the lower bag portion 2 defines a second surface thereof opposite to the first surface. The upper bag portion 1 has at least one side edge, while the lower bag portion 2 has at least one side edge correspondingly seal-connected to the side edge of the upper bag portion 1. Thus, the receiving space 3 is formed between the upper bag portion 1 and the lower bag portion 2, and can be used to receive a fertilizer 5. Furthermore, the upper bag portion 1 and the lower bag portion 2 can be selectively formed with a sealable opening (not shown) on one of the side edge thereof. For example, the sealable opening can be a zipper lock opening, so that a user can reuse the nutrient supplying bag to repeatedly fill the fertilizer 5 through the sealable opening. Moreover, because the nutrient supplying bag can prevent the fertilizer 5 from being directly exposed on the soil, it can avoid uncomfortable smells of the fertilizer 5 and efficiently improve hygienic problems of fertilizing plants.

Referring again to FIGS. 2 and 3, in the first preferred embodiment of the present invention, the upper bag portion 1 comprises a liquid inlet 11, a lid 12, a support 13, and a separation screen 14. The liquid inlet 11 is passing through the upper bag portion 1 to communicate the receiving space 3 and an external environment, so that a liquid can be filled into the receiving space 3 through the liquid inlet 11. Preferably, the liquid inlet 11 is formed on a first position adjacent to one of corners of the upper bag portion 1.

Referring back to FIGS. 2 and 3, in the first preferred embodiment of the present invention, the lid 12 of the upper bag portion 1 has an outer diameter slightly smaller than an inner diameter of the liquid inlet 11, so that a gap will be defined between the lid 12 and the liquid inlet 11. The support 13 has a first end connected to the lid 12 and a second end connected to an annular inner edge of the liquid inlet 11. The support 13 can be selected from various shapes according to actual needs of the user.

In the first preferred embodiment of the present invention, the support 13 can be preferably a hinge element, an elastic member, or a rubber member, which can provide an automatic returning bias. The lid 12 can be manually opened inward by the user, and the lid 12 is automatically returned to close the liquid inlet 11 due to the automatic returning bias when the lid 12 is released by the user. Furthermore, if insects want to enter the liquid inlet 11, the insects can not push the lid 12 due to the automatic returning bias thereof.

Referring back to FIGS. 2 and 3, in the first preferred embodiment of the present invention, the separation screen 14 of the upper bag portion 1 has an outer diameter greater than the inner diameter of the liquid inlet 11, so that an annular outer edge of the separation screen 14 can be attached to the annular inner edge of the liquid inlet 11 for completely separating the liquid inlet 11. Meanwhile, the separation screen 14 is mounted in the receiving space 3, so as to prevent the insects from entering the receiving space 3.

Referring back to FIGS. 2 and 3, in the first preferred embodiment of the present invention, the lower bag portion 2 comprises at least one liquid outlet 21 for draining the liquid in the receiving space 3. The liquid outlet 21 is communicated with the receiving space 3. Preferably, the liquid outlet 21 is formed on a second position adjacent to one of corners of the lower bag portion 2, while the second position of the liquid outlet 21 is opposite to the first position of the liquid inlet 11 in a diagonal relationship of the nutrient supplying bag. Furthermore, the size and number of the liquid outlet 21 can be varied according to actual needs of the user, in order to increase or decrease the drain speed thereof. Moreover, the user can selectively reproduce the liquid outlet 21 according to the size, number, and position thereof, so as to increase the operation convenience and flexibility of using the nutrient supplying bag. In the first preferred embodiment of the present invention, the upper bag portion 1 and the lower bag portion 2 can be preferably made of a plastic material, in order to provide a flexibly water-impermeable structure of the nutrient supplying bag.

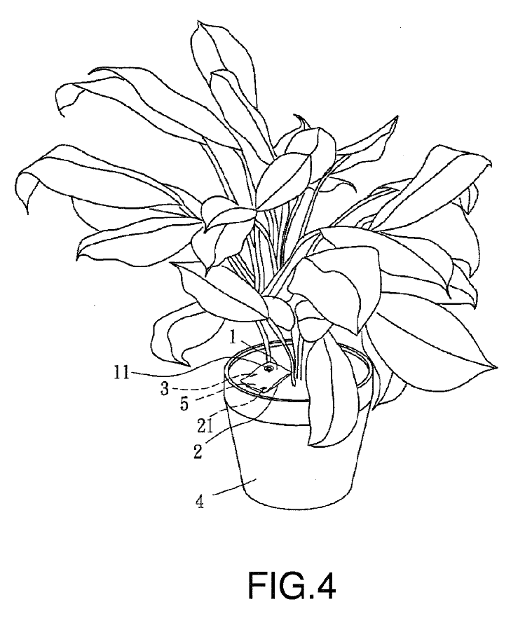

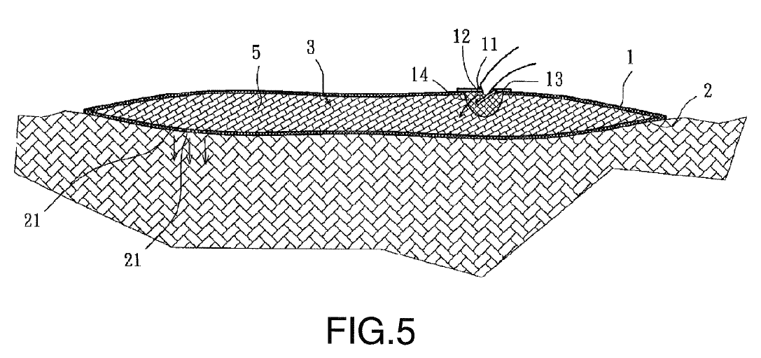

Referring now to FIGS. 4 and 5, when the user uses the nutrient supplying bag of the first preferred embodiment of the present invention, the nutrient supplying bag is firstly used to receive the fertilizer 5 and then be placed on the soil of a suitable position of a pot 4, wherein the lower bag portion 2 of the nutrient supplying bag faces the soil of the pot 4. Because the lower bag portion 2 is made of the plastic material, the flexibly water-impermeable structure of the lower bag portion 2 can be deformed to fit the surface shape of the soil of the pot 4 and the liquid outlet 21 of the lower bag portion 2 can be in tightly contact with the soil. As a result, the contact area between the lower bag portion 2 and the soil can be increased, while the nutrient absorbability of the soil can be also improved. After this, referring to FIG. 5, the user may use a nose (unlabeled) of a watering tool (not shown) to push the lid 12 inward into the liquid inlet 11, so that a liquid (such as water) can be suitably poured into the receiving space 3. Then, when the watering tool is drawn out of the liquid inlet 11, the lid 12 is automatically returned to close the liquid inlet 11 by the support 13. In the first preferred embodiment of the present invention, the liquid outlet 21 is formed on the second position of the bottom of the receiving space 3 opposite to the first position of the liquid inlet 11 in a diagonal relationship for elongating the distance therebetween. Meanwhile, the flexibly water-impermeable structure of the lower bag portion 2 can be deformed to cause an uneven rugged surface of the lower bag portion 2 between the liquid inlet 11 and the liquid outlet 21. Thus, the liquid outlet 21 and the lower bag portion 2 can be used to slow down the draining speed of the liquid in the receiving space 3. Hence, nutrients of the fertilizer 5 may be fully dissolved in the liquid of the receiving space 3. After this, the liquid having the nutrients of the fertilizer 5 can be drained from the receiving space 3 through the liquid outlet 21 and leaked into the soil of the pot 4.

Referring back to FIGS. 4 and 5, when the nutrient supplying bag of the first preferred embodiment of the present invention is used in a rainy day, rainwater can enter the receiving space 3 via the gap between the liquid inlet 11 and the lid 12 for dissolving nutrients of the fertilizer 5, so as to increase the operation convenience and flexibility of using the nutrient supplying bag.

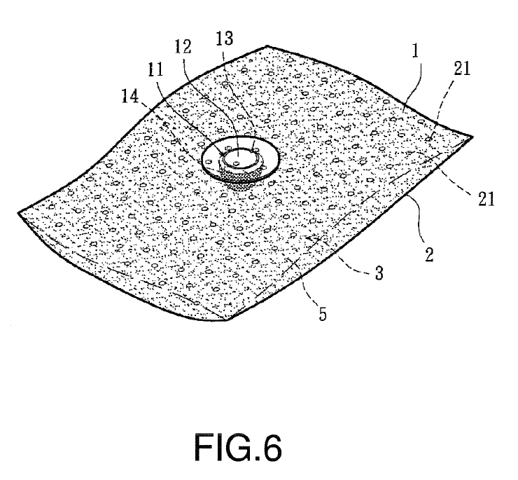

Referring now to FIG. 6, a nutrient supplying bag for plants according to a second preferred embodiment of the present invention is illustrated and similar to the first preferred embodiment. In comparison with the first preferred embodiment, the lower bag portion 2 of the nutrient supplying bag of the second preferred embodiment comprises a plurality of liquid outlets 21 which are evenly dispersed on the surface of the lower bag portion 2. Meanwhile, the upper bag portion 1 comprises a liquid inlet 11 which is formed on a central position of the surface of the upper bag portion 1 and corresponding to the evenly dispersed liquid outlets 21. In the second preferred embodiment of the present invention, the flexibly water-impermeable structure of the lower bag portion 2 can be also deformed to fit a surface shape of the soil, the liquid outlets 21 of the lower bag portion 2 can be in contact with the soil, and an uneven rugged surface of the lower bag portion 2 between the liquid inlet 11 and each of the liquid outlets 21 can be generated. As a result, the liquid outlets 21 and the lower bag portion 2 can be also used to slow down the draining speed of the liquid in the receiving space 3, and the liquid having the nutrients of the fertilizer 5 can be evenly leaked into the soil of the pot 4 through the liquid outlets 21 of the lower bag portion 2, so as to be speedily absorbed by plants on the pot 4.

As described above, the traditional fertilizing method for the potted plant may directly spread the fertilizer 9 on the soil, resulting in attracting insects, causing hygienic problems, affecting the aesthetic impression of the whole environment, and lowering the fertilization efficiency for the plant. In comparison with the traditional fertilizing method, the present invention provides the nutrient supplying bag having the receiving space 3 for receiving the fertilizer 5, the liquid inlet 11 for filling the liquid to fully dissolve the nutrients of the fertilizer 5, the liquid outlet 21 for draining the liquid with the nutrients to the soil of the pot 4, so that the plants on the pot 4 can efficiently absorb the nutrients. As a result, the present invention can substantially enhance the hygienic problems and increase the fertilization efficiency for the plants.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A nutrient supplying bag, comprising:
an upper bag portion defining a first surface of the nutrient supplying bag, and having a liquid inlet for filling a liquid;
a lower bag portion defining a second surface of the nutrient supplying bag opposite to the first surface thereof, and having at least one liquid outlet for draining the liquid; wherein the lower bag portion has at least one side edge which is correspondingly seal-connected to at least one side edge of the upper bag portion;
a receiving space formed between the upper bag portion and the lower bag portion for receiving a fertilizer which has nutrients dissolved in the liquid;
a lid having an outer diameter slightly smaller than an inner diameter of the liquid inlet, so that a gap is defined between the lid and the liquid inlet; and
a support having a first end connected to the lid and a second end connected to an inner edge of the liquid inlet; wherein the lid can be pushed inward into the liquid inlet by a watering tool, so that the liquid can be poured into the receiving space.

2. The nutrient supplying bag of claim 1, wherein the upper bag portion and the lower bag portion is formed with a sealable opening on one of the side edge thereof for filling the fertilizer into the receiving space.

3. The nutrient supplying bag of claim 1, wherein the support is a hinge element that provides an automatic returning bias.

4. The nutrient supplying bag of claim 1, further comprising a separation screen, wherein the separation screen has an outer diameter greater than the inner diameter of the liquid inlet, so that an outer edge of the separation screen is attached to an inner edge of the liquid inlet for completely separating the liquid inlet; and wherein the separation screen is mounted in the receiving space.

5. The nutrient supplying bag of claim 1, wherein the liquid outlet is formed on a position adjacent to one of corners of the lower bag portion.

6. The nutrient supplying bag of claim 5, wherein the liquid inlet is formed on a position adjacent to one of corners of the upper bag portion, while the position of the liquid inlet is opposite to the position of the liquid outlet in a diagonal relationship of the nutrient supplying bag.

7. The nutrient supplying bag of claim 6, wherein the lower bag portion provide a flexibly water-impermeable structure, so that the lower bag portion can be deformed to fit a surface shape of a soil, the liquid outlet of the lower bag portion can be in contact with the soil, and an uneven rugged surface of the lower bag portion between the liquid inlet and the liquid outlet can be generated.

8. The nutrient supplying bag of claim 1, wherein the lower bag portion has a plurality of the liquid outlets which are evenly dispersed on a surface of the lower bag portion.

9. The nutrient supplying bag of claim 8, wherein the liquid inlet of the upper bag portion is formed on a central position of a surface of the upper bag portion and corresponding to the evenly dispersed liquid outlets.

10. The nutrient supplying bag of claim 9, wherein the lower bag portion provide a flexibly water-impermeable structure, so that the lower bag portion can be deformed to fit a surface shape of a soil, the liquid outlets of the lower bag portion can be in contact with the soil, and an uneven rugged surface of the lower bag portion between the liquid inlet and each of the liquid outlet can be generated.
